(19) United States
(12) Patent Application Publication
(10) Pub. No.: US 2026/0219991 A1
(43) Pub. Date: Jul. 30, 2026

(54) REPLACEMENT POLICY FOR ACCESS GRANULARITY IN MEMORY SUBSYSTEMS

(71) Applicant: Micron Technology, Inc., Boise, ID (US)

(72) Inventors: Marco Sforzin, Cernusco Sul Naviglio (IT); Su Wei Lim, Penang (MY); Emanuele Confalonieri, Segrate (IT)

(21) Appl. No.: 19/435,468

(22) Filed: Dec. 29, 2025

Related U.S. Application Data
(60) Provisional application No. 63/749,883, filed on Jan. 27, 2025.

(51) Int. Cl. G06F 11/10

(52) U.S. Cl. CPC G06F 11/1096

(57) ABSTRACT

Methods, systems, and devices for replacement policy for access granularity in memory subsystems are described. The memory system may include one or more extra capacity dies configured to store corrected data from failed memory dies. A failed memory die may include a threshold quantity of errors. The memory system may identify one or more failed memory dies and may correct errors in the stored data using a data correction scheme supported by the memory system. The memory system may select at least one extra capacity die and may write the corrected data to the selected extra capacity die. The memory system may write null data in the failed memory die to replace the data including the errors. The extra capacity die may thereby act as a replacement for at least a portion of the failed memory die.

### CROSS REFERENCE

The present Application for Patent claims priority to U.S. patent application Ser. No. 63/749,883 by Sforzin et al., entitled “REPLACEMENT POLICY FOR ACCESS GRANULARITY IN MEMORY SUBSYSTEMS,” filed Jan. 27, 2025, which is assigned to the assignee hereof, and which is expressly incorporated by reference in its entirety herein.

### TECHNICAL FIELD

The following relates to one or more systems for memory, including replacement policy for access granularity in memory subsystems.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports replacement policy for access granularity in memory subsystems in accordance with examples as disclosed herein.

FIGS. 2A-2D show examples of die replacement schemes that support replacement policy for access granularity in memory subsystems in accordance with examples as disclosed herein.

FIG. 3 shows a block diagram of a memory system that supports replacement policy for access granularity in memory subsystems in accordance with examples as disclosed herein.

FIG. 4 shows a flowchart illustrating a method that supports replacement policy for access granularity in memory subsystems in accordance with examples as disclosed herein.

### DETAILED DESCRIPTION

Some memory systems may include multiple memory dies. In some examples, a memory die may fail if a threshold quantity of errors occur in data stored in the memory die. A memory system may use an error control scheme for detection of a failed memory die and correction of the errors in the data stored to the failed memory die. The error control scheme may be a single die data correction (SDDC) scheme or a double die data correction (DDDC) scheme, among other examples. In some examples, the memory system may use the error control scheme and one or more codewords associated with the failed memory die to correct the data. For example, a codeword may include data from the memory die and multiple other memory dies along with parity information stored to one or more parity dies within a data stripe of the memory system. The memory system may fix the failed memory die by writing the corrected data back to the memory die. However, a failed memory die may be susceptible to additional subsequent errors, which may decrease reliability of the data and increase a possibility for the memory system to experience uncorrectable errors.

Techniques, systems, and devices described herein provide for a memory system to include one or more extra capacity dies configured to store corrected data from failed memory dies, thereby increasing a reliability and error correction capability of the memory system. The one or more extra capacity dies may be configured upon initialization of the memory system along with one or more data dies configured to store data for operations of the memory system and one or more parity dies configured to store parity information associated with the data. A data stripe within the memory system may include a set of data dies, one or more extra capacity dies, and one or more parity dies, where each data stripe may include one or more codewords that can be used to correct errors in data within the data stripe. A data strip may correspond to an access granularity at which the memory system is accessed, in some examples.

If the memory system identifies one or more failed memory dies (e.g., one die for a single die data correction (SDDC) scheme or two dies for a double die data correction (DDDC) scheme), the memory system may correct the data using a corresponding codeword and a data correction scheme supported by the memory system. The memory system may select at least one extra capacity die, or one or more banks of the extra capacity die, and may store the corrected data to the selected extra capacity die. After writing the corrected data to the extra capacity die, the memory system may replace the errored data in the failed memory die with null data (e.g., all zeros, random data, dummy data, or the like) when obtaining the codeword for subsequent error corrections, which may be referred to as padding the failed die. In some examples, the memory system may perform such die correction and replacement techniques at a bank-level granularity, or some other granularity. For example, the memory system may correct and replace failed data in one or more failed banks within a die, or within the entire die, or according to some other level of granularity. The memory system may replace a quantity of failed memory dies that is less than or equal to a quantity of extra capacity dies (e.g., if the memory system includes six extra capacity dies, it may replace up to six failed memory dies). After writing corrected data to all extra capacity dies in the memory system, the memory system may continue to correct data in failed dies in accordance with the data correction scheme, but may not replace those dies.

In addition to applicability in memory systems as described herein, techniques for replacement policy for access granularity in memory subsystems may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory reliability and error correction capability, which may decrease processing or latency times associated with performing error correction on failed memory dies or banks, among other benefits.

Features of the disclosure are illustrated and described in the context of systems and architectures. Features of the disclosure are further illustrated and described in the context of die replacement schemes and flowcharts.

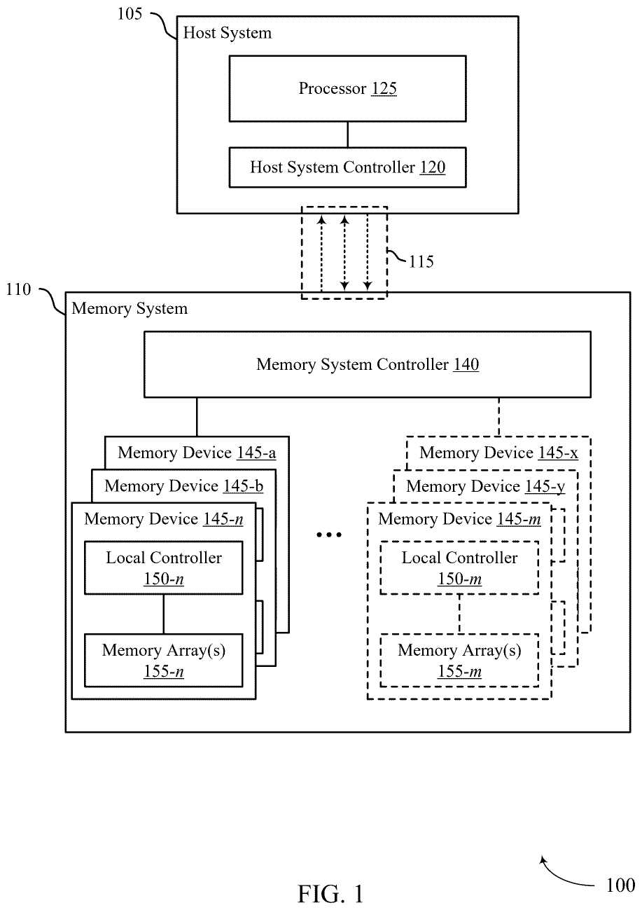

FIG. 1 shows an example of a system 100 that supports replacement policy for access granularity in memory subsystems in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

In some examples, the memory system 110 may include a first set of one or more memory devices 145 (e.g., memory device 145-a, memory device 145-b, up to memory device 145-n) and a second set of one or more memory devices 145 (e.g., memory device 145-x, memory device 145-y, up to memory device 145-m). In some cases, the first set of one or more memory devices 145 may be configured to store data and parity information associated with the data. Additionally, or alternatively, the second set of one or more memory devices 145 may be configured to store corrected data from the first set of memory devices 145 in accordance with a die replacement scheme described herein.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

Some memory systems 110 may include multiple memory devices 145 that include multiple memory dies, and each memory die may include multiple memory banks. In some examples, a respective memory die or bank may fail when a threshold quantity of errors occur in data stored in the memory die or bank. The memory system 110 may use an error control scheme for detection of a failed memory die or bank and correction of the data. For example, some memory systems 110 may detect and correct data in accordance with a SDDC scheme or a DDDC scheme, among other examples. In some examples, the memory system 110 may use parity information and one or more codewords associated with the failed memory die or bank to correct the data. However, while correcting the data may enable the host system 105 to access the data, failed memory dies or banks that may be susceptible to further errors, and a capability of the memory system 110 to correct errors may be reduced.

A memory system 110 may include one or more extra capacity dies configured to store corrected data from failed memory dies or banks in accordance with the techniques described herein, thereby increasing the capability of the memory system 110 to correct errors. For example, the memory system 110 may identify one or more failed memory dies or banks and select at least one extra capacity die, or one or more banks of the extra capacity die, to store the corrected data from the one or more failed memory dies or banks. Based on writing the corrected data to the extra capacity die, the memory system 110 may write null data in the failed memory die or bank. The memory system 110 may replace failed memory dies or banks up to the quantity of extra capacity dies (e.g., if the memory system 110 includes six extra capacity dies, the memory system 110 may replace six failed memory dies). After writing corrected data to all extra capacity dies in the memory system 110, the memory system 110 may continue to correct data in failed dies or banks in accordance with the data correction scheme.

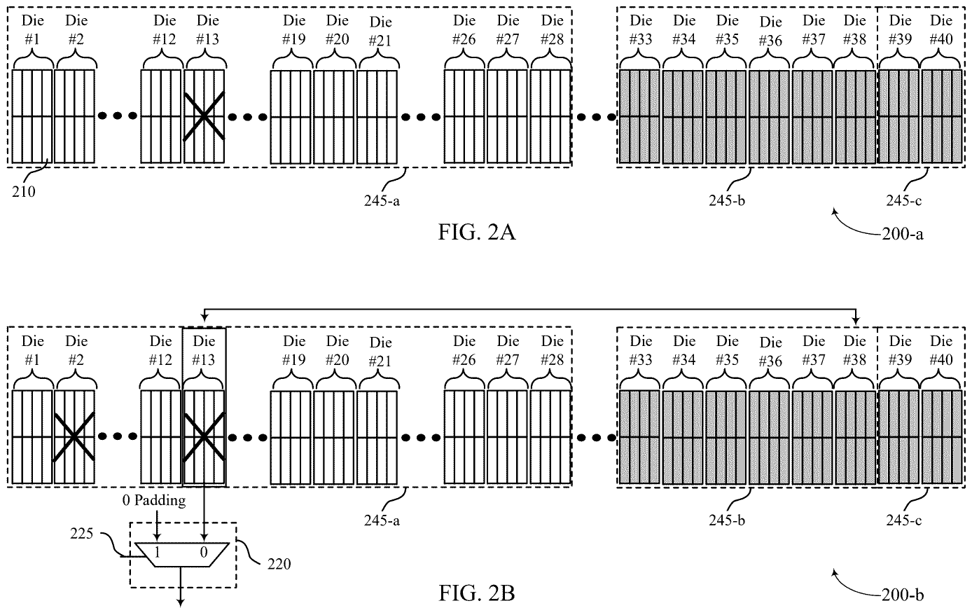

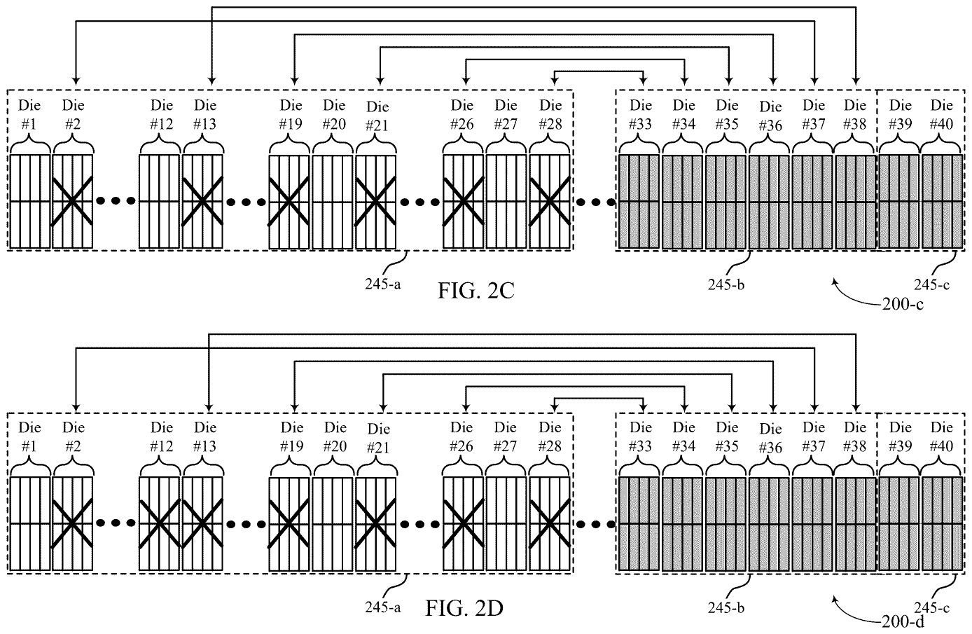

FIGS. 2A-2D show examples of die replacement schemes 200 that support replacement policy for access granularity in memory subsystems in accordance with examples as disclosed herein. The die replacement schemes 200-a through 200-d may implement or be implemented by aspects of the system 100 as described with reference to FIG. 1. For example, the die replacement schemes 200-a through 200-d illustrate techniques for moving corrected data from a failed memory die to an extra capacity die 205 within a memory system including multiple memory dies, which may represent examples of the memory devices 145 described with reference to FIG. 1.

In this example, the memory system may include one or more data dies 245-a, one or more parity dies 245-c, and one or more extra capacity dies 245-b. The memory system may configure the allocation of the data dies 245-a, the extra capacity dies 245-b, and the parity dies 245-c after initialization of the memory system, based on an indication received from a host system, or both. The data dies 245-a may be configured to store data within the memory system. For example, the data dies 245-a may store data for one or more host applications, metadata, or the like. The data dies 245-a may be accessed during access operations to the memory system. The parity dies 245-c may be configured to store parity information for an error correction scheme supported by the memory system. For example, the parity dies 245-c may store parity bits associated with the data stored across the data dies 245-a. The parity bits may be used to perform single die data correction (SDDC), double die data correction (DDDC), or some other error correction scheme supported by the memory system.

The extra capacity dies 245-b may be configured to store random data, extra data (e.g., data associated with other operations of the memory system), or both during initial operations of the memory system and may be configured as available for storage of corrected data moved from one or more of the data dies 245-a in response to detection of an error in the one or more data dies 245-a. For example, the techniques described herein may provide for a progressive or iterative replacement strategy. Each time a data die 245-a experiences a failure (e.g., at least a threshold quantity of errors), a spare resource from one of the extra capacity dies 245-b may be used to replace the failed data die 245-a.

As described herein, by including the extra capacity dies 245-b, the memory system may support improved reliability and performance as compared with systems that do not include extra capacity dies 245-b. For example, if a system does not include any extra capacity dies 245-b, and one of the data dies 245-a experiences an error or other failure, the memory system may correct the data die 245-a using a supported data correction scheme. However, the memory system may be capable of correcting up to one die (e.g., SDDC) or two dies (e.g., DDDC) at a time. As such, the likelihood of the data dies 245-a continuing to experience the same failures and two or more data dies 245-a failing at the same time may be relatively high. Thus, by replacing the data dies 245-a after any failure is detected and using the extra capacity memory dies 245-b, the memory system may improve reliability of data storage.

In the examples of FIGS. 2A through 2D, each of the memory dies may include eight access bits (e.g., DQ[0:3]). For example, each memory die may include eight symbols 210, where each symbol 210 is a single symbol 210 of the eight access bits. Thus, each memory die may store up to 64 bits. In the example illustrated in FIGS. 2A through 2D, the memory system may include 32 data dies 245-a, six extra capacity dies 245-b, and two parity dies 245-c. In this example, the memory system may support a 256 byte (B) access granularity (e.g., 32 data dies 245-a multiplied by 64 bits per die=256B). The 256B access granularity is illustrated for exemplary purposes. It is to be understood that the described techniques may be applied to a 256B access granularity or any other access granularity, including larger or smaller access granularities not illustrated herein.

The two parity dies 245-c may support a first data correction capability. For example, the two parity dies 245-c may support an SDDC functionality, in which up to one data die of the data dies 245-a may be corrected at a given time (e.g., a single die per error correction operation). A codeword for performing SDDC may be a first size of 320B in this example (e.g., including 16B parity information, 256B of data in the data dies 245-a, and 48B of extra data in the extra capacity dies 245-b). In some examples, there may be four parity dies 245-c, or some other quantity of parity dies 245-c. In such cases, a total quantity of parity dies 245-c and extra capacity dies 245-b may sum to eight. For example, if there are four parity dies 245-c, there may be four extra capacity dies 245-b, and the like. A total quantity of parity dies 245-c and extra capacity dies 245-b may be equal to some other quantity that is based on the access granularity of the memory system, the quantity of data dies 245-a, and the like.

The data dies 245-a, the extra capacity dies 245-b, and the parity dies 245-c illustrated in FIGS. 2A through 2D may represent an example of a data stripe for error correction (e.g., an SDDC stripe or a DDDC stripe). In some examples, each data stripe may include one codeword, two codewords, or some other quantity of codewords. If each die is divided into four 16-bit symbol groups (e.g., four groups of two symbols 210), then each die may include a first symbol group 0 (represented by the two symbols 210 in the top left corner of each respective die in FIGS. 2A through 2D), a second symbol group 1 (represented by the two symbols 210 in the top right corner of each respective die in FIGS. 2A through 2D), a third symbol group 2 (represented by the two symbols 210 in the bottom left corner of each respective die in FIGS. 2A through 2D), and a fourth symbol group 3 (represented by the two symbols 210 in the bottom right corner of each respective die in FIGS. 2A through 2D). A first codeword may include all even symbol groups (e.g., symbol groups 0 and 2 in each of the dies #0 through #40), and a second codeword may include all odd symbol groups (e.g., symbol groups 1 and 3 in each of the dies #0 through #40). Additionally, or alternatively, a first codeword may include symbol groups 0 and 1 in each die, and the second codeword may include symbol groups 2 and 3 in each die, or some other combination of symbol groups across dies, such that the data stripe includes two codewords. Dice in each codeword may be from different physical channels or different physical ranks, in some examples.

If there are four or more parity dies 245-c, the memory system may support a data correction scheme capable of correcting more errors than the SDDC scheme, such as a DDDC scheme, based on an increased quantity of parity bits. However, a capacity for replacing failed data dies from among the data dies 245-a may decrease as the quantity of extra capacity dies 245-b decreases. For example, if there are six extra capacity dies 245-b, as illustrated in FIGS. 2A through 2D, up to six data dies 245-a may be replaced. However, if there are four extra capacity dies 245-b, up to four data dies 245-a may be replaced. That is, the relationship between quantities of replaceable data dies 245-a and quantities of extra capacity dies 245-c may be one-to-one.

It is to be understood that the memory die sizes and quantities illustrated in FIGS. 2A through 2D are for exemplary purposes, and the described techniques may be supported by any quantity and size of memory dies, including those not illustrated.

FIG. 2A illustrates a first example die replacement scheme 200-a. The first example die replacement scheme illustrates dies within a memory system before any replacement is performed. For example, the memory system may be configured to include at least the illustrated 32 data dies 245-a, six extra capacity dies 245-b, and two parity dies 245-c. The extra capacity dies 245-b may store extra data associated with one or more other operations of the memory system, null data, random data, or the like.

In the example of the die replacement scheme 200-a, the memory system may detect a failure associated with the die #13, which may be one of the data dies 245-a. For example, an error correction engine (e.g., an error correction code (ECC) core) within the memory system may detect that the data stored in one or more symbols 210 of the die #13 includes at least one error. The memory system may not detect errors in other data dies 245-a. A failed memory die as described herein may represent a die that includes at least one error, or some other threshold quantity of errors.

In some examples, a failed memory die may include errors throughout the memory die. Additionally, or alternatively, a failed memory die may include one or more failed banks of data and one or more other banks of data that included valid (e.g., correct) data without errors. A bank may represent a portion of a symbol 210, or some other granularity of data within each of the dies. In some examples, each symbol 210 may represent a bank-group including eight banks, or some other quantity.

In this example, the memory system may support SDDC. As such, the memory system may be capable of correcting errors in a single data die 245-a using a codeword that includes data from each of the data dies 245-a, extra data from each of the extra capacity dies 245-b, and parity information from the parity dies 245-c. For example, the two parity dies 245-c may support SDDC functionality using a codeword of a first size. In some examples, the error correction engine may support a 16-bit data correction scheme, such as a 16 bit 2xReed Solomon (RS)2(80,76) scheme, or some other type of correction scheme, including an 8-bit scheme, or other scheme. The 16 bit 2xRS2(80,76) scheme may enable the memory system to correct up to two symbols using two codewords, where each codeword may be 80 bits long and the payload of each codeword may be 76 bits long. In some examples, a length of each codeword may be based on a single die correction (SDC) threshold (e.g., longer codeword lengths may enable the memory system to correct more errors).

FIG. 2B illustrates a second example of a die replacement scheme 200-b. The die replacement scheme 200-b may illustrate allocations of the dies in FIG. 2A after the die #13 is replaced. For example, after detecting the error in the die #13, the memory system (e.g., the ECC engine) may perform a data correction operation in accordance with a supported data correction scheme (e.g., SDDC) to correct the data in the die #13.

As described herein, instead of writing the corrected data back to the die #13, the memory system may write the corrected data to one of the extra capacity dies 245-b. For example, the die #13 may be relatively more likely than other dies to experience failure again or otherwise experience continued errors over time. Thus, to improve reliability of the memory system (e.g., to reduce a quantity of subsequent error correction operations for the same die), the memory system may replace the die #13 with one of the extra capacity dies 245-b, such as the die #38.

Replacement of the die #13 may refer to moving the data from the die #13 to the replacement die #38. Subsequent accesses to the data may thereby be sourced from the die #38 instead of the die #13. In some examples, the memory system may replace all of the die #13 (e.g., a full die replacement). Additionally, or alternatively, the memory system may replace a portion of the die #13. For example, the memory system may perform die replacement at a bank level, or some other granularity within a memory die (e.g., at a block level). If the one or more detected errors are included in a quantity of one or more banks of the die #13, but not in all of the banks of the die #13, the memory system may, for example, correct the data in the identified banks and write the corrected data to a corresponding quantity of banks in the replacement die #38, but may not write to all banks in the replacement die #38, which may induce a smaller extra capacity reduction in each replacement (e.g., 1/32 smaller than a full die replacement).

In some examples, the memory system may select the replacement die #38 based on one or more parameters or criteria (e.g., a location of the replacement die #38, an availability of the replacement die #38 to store data, among other examples). For example, the memory system may select the replacement die #38 based on a location of the replacement die #38 from among the extra capacity dies 245-b (e.g., the memory system may select the last available replacement die from among the extra capacity dies 245-b). In another example, the memory system may select the replacement die #38 based on the replacement die #38 being available to store the corrected data. In some cases, the memory system may select the replacement die #38 while the replacement die #38 stores other data (e.g., data from a previous replacement scheme). In such cases, the memory system may move the data to another memory die (e.g., another replacement die or to a data die) before writing the corrected data to the replacement die #38.

The memory system may route, via a multiplexer 220, data from die #13 or null data towards an ECC engine based on whether the memory system wrote the corrected data to the replacement die #38 (e.g., or at least a portion of the replacement die #38). The ECC engine may implement data correction decoding (e.g., SDDC decoding, DDDC decoding, or both) via one or more RS decoders. If the corrected data was written to the replacement die #38, a replacement flag 225 may be set to a first value (e.g., ‘1’), and the memory system may input null data into the ECC engine (e.g., to one or more RS decoders) to replace the previous data including the errors. That is, the multiplexer 220 may pad the data in die #13 with the null data (e.g., all “0” bits, or some other dummy data or random data), which may be referred to as writing the null data to replace the data previously stored to the die #13. For example, if the corrected data was not written to the replacement die #38, the replacement flag 225 may be set to a second value (e.g., ‘0’), and the memory system may input the data from die #13 (e.g., corrected data) to the ECC engine for codeword generation. In some examples, the memory system may route the data or null data via the multiplexer 220 based on performing a read operation (e.g., a read operation corresponding to the data from die #13 or the corrected data from replacement die #38) as part of a codeword generation. The codeword used by the memory system for correction may thereby include the null data instead of the previous data stored to the failed die based on the failed die being replaced.

In some examples, the die #13 may be associated with one or more codewords. For example, a first codeword may include a first set of symbols 210 of the die #13 and a second codeword may include a second set of symbols 210 of the die #13. In another example, the first codeword may include all of the symbols 210 of the die #13. The one or more codewords may further include data stored in data dies 245-a, data stored in the extra capacity dies 245-b, and parity information stored in the parity dies 245-c. Before correcting and replacing the data in die #13 with the null data, the one or more codewords may have a first length (e.g., 80 symbols long). After correcting and replacing the data in die #13 with the null data, the first codeword, the second codeword, or both, may have a second length shorter than the first length based on writing the null data in the die #13. For example, the one or more codewords may include the data stored in a subset of the data dies 245-a and in the replacement die #38, the parity information, and the null data padded to (e.g., written over) the previous data stored in the die #13.

The memory system may store information (e.g., metadata information) associated with the die replacement scheme 200-b. For example, the memory system may store information that indicates which of the data dies 245-a are replaced with one of the extra capacity dies 245-b, which of the extra capacity dies 245-b store data from the data dies 245-b, or both. In some examples, the information may indicate one or more banks within the die #13 that include the null data (e.g., that include replaced data to be padded with the null data during an access operation). Additionally, or alternatively, the information may further indicate one or more banks within the replacement die #38 that are used to store the corrected data. In the example illustrated in FIG. 2B, the memory system may store the information in 132 bits. For example, in a 480 dice system, nine bits may be used to identify a respective die from the data dies 245-a. Each die may include, in some examples, 32 banks that may be identified using five bits (e.g., 14 bits total to identify a bank in the memory system). 84 bits may store failed banks based on the extra capacity dies 245-b replacing, in some examples, Six banks (e.g., 6×14=84). Eight bits may identify a bank in the extra capacity dies 245-b, and 48 bits (e.g., 6×8=48) may identify the banks used as stored banks (e.g., 48 +84=132 bits to store replacement information).

FIG. 2B illustrates an example die replacement scheme 200-b in accordance with an SDDC scheme, but it is to be understood that the described techniques may be applied to a DDDC scheme. For example, the memory system may include four extra capacity dies 245-b and four parity dies 245-c, and the memory system may correct up to two dies (e.g., die #13 and another die from among the data dies 245-a) concurrently, and the data within each of the two dies may be corrected and replaced in accordance with the techniques described herein.

FIG. 2C illustrates a third example of a die replacement scheme 200-c. The die replacement scheme 200-c may illustrate allocations of the dies in FIG. 2B after multiple data dies 245-a have been replaced. For example, the memory system as described herein may continue to perform operations, detect failed data dies from among the data dies 245-a, and replace the failed data dies from among the data dies 245-a iteratively until all of the extra capacity dies 245-b have been used.

After correcting the data failed in the die #13 and replacing the die #13, as illustrated in FIG. 2B, the memory system may subsequently detect that another die, such as the die #2, is failed. That is, the memory system may detect at least a threshold quantity of errors within the die #2. The memory system (e.g., the ECC engine) may correct the errored data in the die #2 using a corresponding codeword from within the data stripe and according to the data correction scheme (e.g., SDDC). The memory system may write the corrected data to the die #37, which may be an available extra capacity die 245-b. The memory system may pad the failed die #2 with null data when generating the corresponding codeword, as described with reference to FIG. 2B. As described herein, in some examples, the full die #2 may fail and be replaced. Additionally, or alternatively, a portion of the die #2, such as a subset of banks within the die #2, may fail and the memory system may be capable of correcting the erred data within the subset, writing the corrected data to a subset of banks within the extra capacity die #37, and padding data in the subset of banks of the die #2 with null data (e.g., while remaining banks in the die #2 store valid data that is input to the codeword generation).

The memory system may continue to iteratively replace failed data dies from among the data dies 245-a or portions of failed data dies from among the data dies 245-a until all of the extra capacity dies 245-c are used. For example, the memory system may subsequently correct data in the die #19, write the corrected data to the die #36, and pad the die #19 with null data, correct data in the die #21, write the corrected data to the die #35, and pad the die #21 with null data, correct data in the die #26, write the corrected data to the die #34, and pad the die #26 with null data, correct data in the die #28, write the corrected data to the die #33, and pad the die #28 with null data, in that order or any other order in which errors in the data dies 245-a are detected. If the memory system detects more than one failed data die 245-a at a time, and the memory system supports SDDC, the memory system may not be capable of correcting the data in both of the failed data dies from among the data dies 245-a, which may cause a failure. As such, the memory system may support the die replacement scheme described herein for a single data die 245-a at a time.

Although the replacements are illustrated as a one-to-one mapping in FIG. 2C, it is to be understood that, in some examples, the memory system may use a single extra capacity die 245-b to replace data in respective portions of two or more data dies 245-a. For example, if a bank in the die #12 fails, the memory system may correct the data in the bank and write the corrected data to a bank in an extra capacity die 245-a (e.g., the die #33, for example). If the memory system subsequently detects a failed bank in another die, such as the die #27, the memory system may correct the data in the bank and write the corrected data to another bank in the same extra capacity die #33. Thus, a single extra capacity die may store corrected data for more than two failed data dies from among the data dies 245-a, in some examples.

The memory system may store replacement information that indicates locations of each of the failed data dies from among the data dies 245-a and failed banks within the data dies 245-a, as well as locations of each of the extra capacity dies 245-b and banks within the extra capacity dies 245-b that are used to store replacement data (e.g., corrected data), as described in further detail elsewhere herein, including with reference to FIG. 2B.

The memory system may thereby perform iterative die replacements when one or more data dies 245-a fail, up to an available extra capacity. The available extra capacity may be reduced with each replacement. For example, the extra capacity may start at around 20 percent of a total capacity of the data stripe, or some other percentage, and may be reduced with each replacement until the available extra capacity is zero. Each full-die replacements may reduce the available extra capacity more than bank-level replacements.

Although the data correction scheme described with reference to FIGS. 2A through 2D is an SDDC scheme, it is to be understood that the described techniques may be applied to any other types of data correction schemes capable of correcting errors in any quantity of one or more data dies 245-a. For example, if the memory system supports a DDDC scheme, there may be less available extra capacity (e.g., four extra capacity dies 245-b instead of six extra capacity dies 245-b), but the memory system may be able to correct more errors with each iteration. For example, if the memory system detects two failed data dies, failed banks in two data dies 245-a, or both, the memory system may use the corresponding codeword and the DDDC scheme to simultaneously correct the two failed data dies, which may improve reliability and performance as compared with SDDC. The memory system may write the corrected data for two data dies 245-a to one or more corresponding extra capacity dies 245-b, and may pad the two data dies 245-a with null data at the same or sequential times. Thus, higher order data correction schemes may improve reliability and performance, but may reduce extra capacity available and a quantity of replaceable data dies 245-a.

FIG. 2D illustrates a fourth example of a die replacement scheme 200-c. The die replacement scheme 200-c may illustrate allocations of the dies in FIG. 2D after another failed die is detected. For example, the memory system as described herein may continue to perform operations, detect failed data dies from among the data dies 245-a, and perform data correction operations after the memory system uses all of the extra capacity dies 245-b.

Once the last extra capacity die 245-b is used, the memory system may continue to support error correction using the codeword including the null data in any of the previously failed and replaced data dies 245-a, as well as the corrected data in the extra capacity dies 245-b. However, instead of writing the corrected data to an extra capacity die 245-b, the memory system may correct the data and write the corrected data back to the data die 245-a. In the example of FIG. 2D, the memory system may detect a threshold quantity of errors in the data die #12, which may indicate a failure at the die-level or a bank-level. The memory system may correct the data using the SDDC scheme (e.g., or the DDC scheme, if supported). The memory system may write the corrected data back to the die #12 to replace the previous data that included the errors. The memory system may thereby continue to operate until a quantity of detected errors exceeds a correction capability of the memory system.

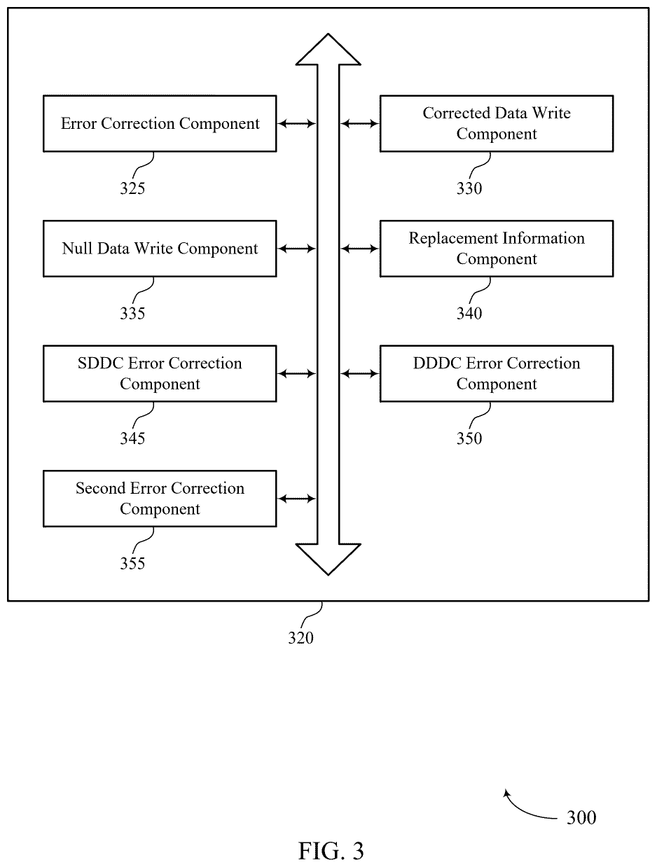

FIG. 3 shows a block diagram 300 of a memory system 320 that supports replacement policy for access granularity in memory subsystems in accordance with examples as disclosed herein. The memory system 320 may be an example of aspects of a memory system as described with reference to FIGS. 1 through 2. The memory system 320, or various components thereof, may be an example of means for performing various aspects of replacement policy for access granularity in memory subsystems as described herein. For example, the memory system 320 may include an error correction component 325, a corrected data write component 330, a null data write component 335, a replacement information component 340, an SDDC error correction component 345, a DDDC error correction component 350, a second error correction component 355, or any combination thereof. Each of these components, or components of subcomponents thereof (e.g., one or more processors, one or more memories), may communicate, directly or indirectly, with one another (e.g., via one or more buses).

The error correction component 325 may be configured as or otherwise support a means for correcting, in accordance with a data correction scheme supported by the memory system, one or more errors in first data stored in at least a first die of a plurality of first dies of the memory system, where the memory system includes: the plurality of first dies for storing data; a plurality of second dies for storing parity information associated with the data correction scheme; and one or more extra capacity dies for storing corrected data from one or more first dies of the plurality of first dies in accordance with a die replacement scheme supported by the memory system. The corrected data write component 330 may be configured as or otherwise support a means for writing the corrected first data to at least a first extra capacity die of the one or more extra capacity dies in accordance with the die replacement scheme. The null data write component 335 may be configured as or otherwise support a means for writing, based on writing the corrected first data to the first extra capacity die, null data to the first die to replace the first data previously stored to the first die.

In some examples, the error correction component 325 may be configured as or otherwise support a means for correcting, in accordance with the data correction scheme and after writing the null data to the first die, one or more second errors in second data stored in at least a second die of the plurality of first dies of the memory system. In some examples, the corrected data write component 330 may be configured as or otherwise support a means for writing the corrected second data to at least a second extra capacity die of the one or more extra capacity dies in accordance with the die replacement scheme. In some examples, the null data write component 335 may be configured as or otherwise support a means for writing, based on writing the corrected second data to the second extra capacity die, the null data to the second die to replace the second data previously stored to the second die.

In some examples, the error correction component 325 may be configured as or otherwise support a means for correcting, in accordance with the data correction scheme and after writing respective corrected data to each extra capacity die of the one or more extra capacity dies, one or more third errors in third data stored in at least a third die of the plurality of first dies of the memory system. In some examples, the corrected data write component 330 may be configured as or otherwise support a means for writing the corrected third data to the third die based on each extra capacity die of the one or more extra capacity dies including the respective corrected data.

In some examples, the one or more errors are detected in the first data stored in one or more first banks of the first die; the corrected first data is written to one or more second banks of the first extra capacity die based on the one or more errors being within the one or more first banks of the first die; the null data is written to the one or more first banks of the first die based on the one or more errors being within the one or more first banks of the first die; and second data stored in one or more third banks of the first die includes valid data.

In some examples, to support correcting the one or more errors in the first data, the error correction component 325 may be configured as or otherwise support a means for correcting, in accordance with the data correction scheme and a codeword, the one or more errors in the first data, where the codeword includes the data stored in the plurality of first dies, second data stored in the one or more extra capacity dies, and the parity information.

In some examples, the second error correction component 355 may be configured as or otherwise support a means for correcting, after the corrected first data is written to the first extra capacity die and the null data is written to the first die in accordance with the die replacement scheme, one or more second errors in second data stored in at least a second die of the plurality of first dies, where the one or more second errors are corrected in accordance with the data correction scheme and a second codeword, and where the second codeword includes the data stored in a subset of the plurality of first dies and in the first extra capacity die, the parity information, and the null data stored in the first die. In some examples, the codeword includes 256 bits of the data stored within a subset of the plurality of first dies, 48 bits of extra data stored within a subset of the one or more extra capacity dies, and 16 bits of the parity information stored within the plurality of second dies.

In some examples, the replacement information component 340 may be configured as or otherwise support a means for storing, to the memory system, information that indicates the first die includes a replaced die based on writing the null data to the first die and that indicates one or more banks within the first die that include the null data. In some examples, the replacement information component 340 may be configured as or otherwise support a means for storing, to the memory system, information that indicates the first extra capacity die is a replacement die based on writing the corrected first data to the first extra capacity die, and that indicates one or more banks within the first extra capacity die that are used to store the corrected first data.

In some examples, to support correcting the one or more errors in at least the first die, the SDDC error correction component 345 may be configured as or otherwise support a means for correcting the one or more errors in the first die in accordance with the data correction scheme including a single die data correction scheme, where the plurality of second dies includes a first quantity of second dies for storage of the parity information to support the single die data correction scheme. In some examples, to support correcting the one or more errors in at least the first die, the DDDC error correction component 350 may be configured as or otherwise support a means for correcting the one or more errors in the first die and a second die of the plurality of first dies in accordance with the data correction scheme including a double die data correction scheme, where the plurality of second dies includes a second quantity of second dies for storage of the parity information to support the double die data correction scheme, and where the corrected first data is written to the first extra capacity die and a second extra capacity die of the one or more extra capacity dies based on the one or more errors being in the first die and the second die.

In some examples, the one or more extra capacity dies include six extra capacity dies and the die replacement scheme supports writing respective corrected data from up to six dies of the plurality of first dies in accordance with the six extra capacity dies; or the one or more extra capacity dies include four extra capacity dies and the die replacement scheme supports writing respective corrected data from up to four dies of the plurality of first dies in accordance with the four extra capacity dies.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

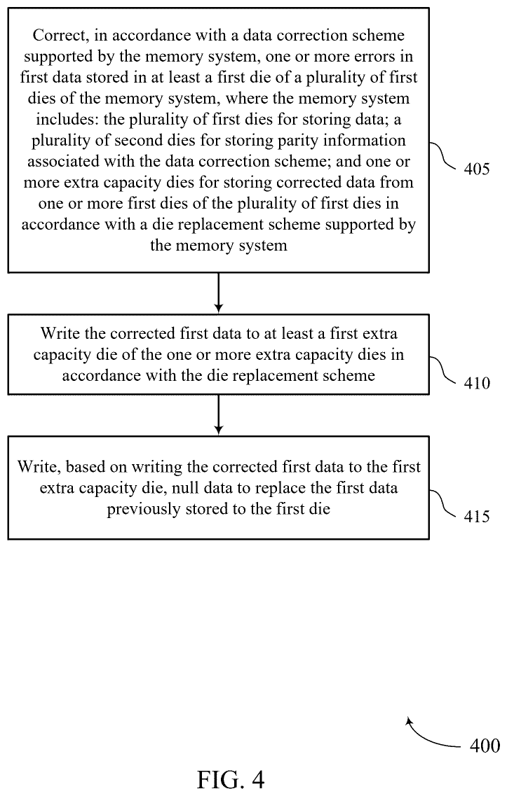

FIG. 4 shows a flowchart illustrating a method 400 that supports replacement policy for access granularity in memory subsystems in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include correcting, in accordance with a data correction scheme supported by the memory system (e.g., DDDC or SDDC), one or more errors in first data stored in at least a first die of a plurality of first dies of the memory system, where the memory system includes: the plurality of first dies for storing data (e.g., a plurality of data dies 245-a, as described with reference to FIGS. 2A-2D); a plurality of second dies for storing parity information associated with the data correction scheme (e.g., a plurality of parity dies 245-c, as described with reference to FIGS. 2A-2D); and one or more extra capacity dies (e.g., the extra capacity dies 245-b, as described with reference to FIGS. 2A-2D) for storing corrected data from one or more first dies of the plurality of first dies in accordance with a die replacement scheme supported by the memory system. In some examples, aspects of the operations of 405 may be performed by an error correction component 325 as described with reference to FIG. 3.

At 410, the method may include writing the corrected first data to at least a first extra capacity die of the one or more extra capacity dies in accordance with the die replacement scheme. In some examples, aspects of the operations of 410 may be performed by a corrected data write component 330 as described with reference to FIG. 3.

At 415, the method may include writing, based on writing the corrected first data to the first extra capacity die, null data to the first die to replace the first data previously stored to the first die (e.g., using a multiplexer 220, as described with reference to FIG. 2B). In some examples, aspects of the operations of 415 may be performed by a null data write component 335 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for correcting, in accordance with a data correction scheme supported by the memory system, one or more errors in first data stored in at least a first die of a plurality of first dies of the memory system, where the memory system includes: the plurality of first dies for storing data; a plurality of second dies for storing parity information associated with the data correction scheme; and one or more extra capacity dies for storing corrected data from one or more first dies of the plurality of first dies in accordance with a die replacement scheme supported by the memory system; writing the corrected first data to at least a first extra capacity die of the one or more extra capacity dies in accordance with the die replacement scheme; and writing, based on writing the corrected first data to the first extra capacity die, null data to the first die to replace the first data previously stored to the first die.
Aspect 2: The method, apparatus, or non-transitory computer-readable medium of aspect 1, further including operations, features, circuitry, logic, means, or instructions, or any combination thereof for correcting, in accordance with the data correction scheme and after writing the null data to the first die, one or more second errors in second data stored in at least a second die of the plurality of first dies of the memory system; writing the corrected second data to at least a second extra capacity die of the one or more extra capacity dies in accordance with the die replacement scheme; and writing, based on writing the corrected second data to the second extra capacity die, the null data to the second die to replace the second data previously stored to the second die.
Aspect 3: The method, apparatus, or non-transitory computer-readable medium of any of aspects 1 through 2, further including operations, features, circuitry, logic, means, or instructions, or any combination thereof for correcting, in accordance with the data correction scheme and after writing respective corrected data to each extra capacity die of the one or more extra capacity dies, one or more third errors in third data stored in at least a third die of the plurality of first dies of the memory system and writing the corrected third data to the third die based on each extra capacity die of the one or more extra capacity dies including the respective corrected data.
Aspect 4: The method, apparatus, or non-transitory computer-readable medium of any of aspects 1 through 3, where the one or more errors are detected in the first data stored in one or more first banks of the first die; the corrected first data is written to one or more second banks of the first extra capacity die based on the one or more errors being within the one or more first banks of the first die; the null data is written to the one or more first banks of the first die based on the one or more errors being within the one or more first banks of the first die; and second data stored in one or more third banks of the first die includes valid data.
Aspect 5: The method, apparatus, or non-transitory computer-readable medium of any of aspects 1 through 4, where correcting the one or more errors in the first data includes operations, features, circuitry, logic, means, or instructions, or any combination thereof for correcting, in accordance with the data correction scheme and a codeword, the one or more errors in the first data, where the codeword includes the data stored in the plurality of first dies, second data stored in the one or more extra capacity dies, and the parity information.
Aspect 6: The method, apparatus, or non-transitory computer-readable medium of aspect 5, further including operations, features, circuitry, logic, means, or instructions, or any combination thereof for correcting, after the corrected first data is written to the first extra capacity die and the null data is written to the first die in accordance with the die replacement scheme, one or more second errors in second data stored in at least a second die of the plurality of first dies, where the one or more second errors are corrected in accordance with the data correction scheme and a second codeword, and where the second codeword includes the data stored in a subset of the plurality of first dies and in the first extra capacity die, the parity information, and the null data stored in the first die.
Aspect 7: The method, apparatus, or non-transitory computer-readable medium of any of aspects 5 through 6, where the codeword includes 256 bits of the data stored within a subset of the plurality of first dies, 48 bits of extra data stored within a subset of the one or more extra capacity dies, and 16 bits of the parity information stored within the plurality of second dies.
Aspect 8: The method, apparatus, or non-transitory computer-readable medium of any of aspects 1 through 7, further including operations, features, circuitry, logic, means, or instructions, or any combination thereof for storing, to the memory system, information that indicates the first die includes a replaced die based on writing the null data to the first die and that indicates one or more banks within the first die that include the null data.
Aspect 9: The method, apparatus, or non-transitory computer-readable medium of any of aspects 1 through 8, further including operations, features, circuitry, logic, means, or instructions, or any combination thereof for storing, to the memory system, information that indicates the first extra capacity die is a replacement die based on writing the corrected first data to the first extra capacity die, and that indicates one or more banks within the first extra capacity die that are used to store the corrected first data.
Aspect 10: The method, apparatus, or non-transitory computer-readable medium of any of aspects 1 through 9, where correcting the one or more errors in at least the first die includes operations, features, circuitry, logic, means, or instructions, or any combination thereof for correcting the one or more errors in the first die in accordance with the data correction scheme including a single die data correction scheme, where the plurality of second dies includes a first quantity of second dies for storage of the parity information to support the single die data correction scheme.
Aspect 11: The method, apparatus, or non-transitory computer-readable medium of any of aspects 1 through 10, where correcting the one or more errors in at least the first die includes operations, features, circuitry, logic, means, or instructions, or any combination thereof for correcting the one or more errors in the first die and a second die of the plurality of first dies in accordance with the data correction scheme including a double die data correction scheme, where the plurality of second dies includes a second quantity of second dies for storage of the parity information to support the double die data correction scheme, and where the corrected first data is written to the first extra capacity die and a second extra capacity die of the one or more extra capacity dies based on the one or more errors being in the first die and the second die.
Aspect 12: The method, apparatus, or non-transitory computer-readable medium of any of aspects 1 through 11, where the one or more extra capacity dies include six extra capacity dies and the die replacement scheme supports writing respective corrected data from up to six dies of the plurality of first dies in accordance with the six extra capacity dies; or the one or more extra capacity dies include four extra capacity dies and the die replacement scheme supports writing respective corrected data from up to four dies of the plurality of first dies in accordance with the four extra capacity dies.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
a plurality of first dies for storing data;
a plurality of second dies for storing parity information associated with a data correction scheme supported by the memory system;
one or more extra capacity dies for storing corrected data from one or more first dies of the plurality of first dies in accordance with a die replacement scheme supported by the memory system; and
processing circuitry coupled with the plurality of first dies, the plurality of second dies, and the one or more extra capacity dies and configured to cause the memory system to:
correct, in accordance with the data correction scheme supported by the memory system, one or more errors in first data stored in at least a first die of the plurality of first dies of the memory system;
write the corrected first data to at least a first extra capacity die of the one or more extra capacity dies in accordance with the die replacement scheme; and
write, based on writing the corrected first data to the first extra capacity die, null data to replace the first data previously stored to the first die.

2. The memory system of claim 1, wherein the processing circuitry is further configured to cause the memory system to:
correct, in accordance with the data correction scheme and after writing the null data to the first die, one or more second errors in second data stored in at least a second die of the plurality of first dies of the memory system;
write the corrected second data to at least a second extra capacity die of the one or more extra capacity dies in accordance with the die replacement scheme; and
write, based on writing the corrected second data to the second extra capacity die, the null data to replace the second data previously stored to the second die.

3. The memory system of claim 1, wherein the processing circuitry is further configured to cause the memory system to:
correct, in accordance with the data correction scheme and after writing respective corrected data to each extra capacity die of the one or more extra capacity dies, one or more third errors in third data stored in at least a third die of the plurality of first dies of the memory system; and
write the corrected third data to the third die based on each extra capacity die of the one or more extra capacity dies comprising the respective corrected data.

4. The memory system of claim 1, wherein:
the one or more errors are detected in the first data stored in one or more first banks of the first die;
the corrected first data is written to one or more second banks of the first extra capacity die based on the one or more errors being within the one or more first banks of the first die;
the null data is written to replace the first data stored in the one or more first banks of the first die based on the one or more errors being within the one or more first banks of the first die; and
second data stored in one or more third banks of the first die comprises valid data.

5. The memory system of claim 1, wherein correcting the one or more errors in the first data comprises the processing circuitry configured to cause the memory system to:
correct, in accordance with the data correction scheme and a codeword, the one or more errors in the first data, wherein the codeword comprises the data stored in the plurality of first dies, second data stored in the one or more extra capacity dies, and the parity information.

6. The memory system of claim 5, wherein the processing circuitry is further configured to cause the memory system to:
correct, after the corrected first data is written to the first extra capacity die and the null data is written to the first die in accordance with the die replacement scheme, one or more second errors in second data stored in at least a second die of the plurality of first dies, wherein the one or more second errors are corrected in accordance with the data correction scheme and a second codeword, and wherein the second codeword comprises the data stored in a subset of the plurality of first dies and in the first extra capacity die, the parity information, and the null data that replaces the first data stored to the first die.

7. The memory system of claim 5, wherein the codeword comprises 256 bits of the data stored within a subset of the plurality of first dies, 48 bits of extra data stored within a subset of the one or more extra capacity dies, and 16 bits of the parity information stored within the plurality of second dies.

8. The memory system of claim 1, wherein the processing circuitry is further configured to cause the memory system to:
store, to the memory system, information that indicates the first die comprises a replaced die based on writing the null data to replace the data in the first die and that indicates one or more banks within the first die that include the null data.

9. The memory system of claim 1, wherein the processing circuitry is further configured to cause the memory system to:
store, to the memory system, information that indicates the first extra capacity die is a replacement die based on writing the corrected first data to the first extra capacity die, and that indicates one or more banks within the first extra capacity die that are used to store the corrected first data.

10. The memory system of claim 1, wherein correcting the one or more errors in at least the first die comprises the processing circuitry configured to cause the memory system to:
correct the one or more errors in the first die in accordance with the data correction scheme comprising a single die data correction scheme, wherein the plurality of second dies comprises a first quantity of second dies for storage of the parity information to support the single die data correction scheme.

11. The memory system of claim 1, wherein correcting the one or more errors in at least the first die comprises the processing circuitry configured to cause the memory system to:
correct the one or more errors in the first die and a second die of the plurality of first dies in accordance with the data correction scheme comprising a double die data correction scheme, wherein the plurality of second dies comprises a second quantity of second dies for storage of the parity information to support the double die data correction scheme, and wherein the corrected first data is written to the first extra capacity die and a second extra capacity die of the one or more extra capacity dies based on the one or more errors being in the first die and the second die.

12. The memory system of claim 1, wherein:
the one or more extra capacity dies comprise six extra capacity dies and the die replacement scheme supports writing respective corrected data from up to six dies of the plurality of first dies in accordance with the six extra capacity dies; or
the one or more extra capacity dies comprise four extra capacity dies and the die replacement scheme supports writing respective corrected data from up to four dies of the plurality of first dies in accordance with the four extra capacity dies.

13. A method by a memory system, comprising:
correcting, in accordance with a data correction scheme supported by the memory system, one or more errors in first data stored in at least a first die of a plurality of first dies of the memory system, wherein the memory system comprises:
the plurality of first dies for storing data;
a plurality of second dies for storing parity information associated with the data correction scheme; and
one or more extra capacity dies for storing corrected data from one or more first dies of the plurality of first dies in accordance with a die replacement scheme supported by the memory system;
writing the corrected first data to at least a first extra capacity die of the one or more extra capacity dies in accordance with the die replacement scheme; and
writing, based on writing the corrected first data to the first extra capacity die, null data to replace the first data previously stored to the first die.

14. The method of claim 13, further comprising:
correcting, in accordance with the data correction scheme and after writing the null data, one or more second errors in second data stored in at least a second die of the plurality of first dies of the memory system;
writing the corrected second data to at least a second extra capacity die of the one or more extra capacity dies in accordance with the die replacement scheme; and
writing, based on writing the corrected second data to the second extra capacity die, the null data to replace the second data previously stored to the second die.

15. The method of claim 13, further comprising:
correcting, in accordance with the data correction scheme and after writing respective corrected data to each extra capacity die of the one or more extra capacity dies, one or more third errors in third data stored in at least a third die of the plurality of first dies of the memory system; and
writing the corrected third data to the third die based on each extra capacity die of the one or more extra capacity dies comprising the respective corrected data.

16. The method of claim 13, wherein:
the one or more errors are detected in the first data stored in one or more first banks of the first die;
the corrected first data is written to one or more second banks of the first extra capacity die based on the one or more errors being within the one or more first banks of the first die;
the null data is written to the replace the first data in the one or more first banks of the first die based on the one or more errors being within the one or more first banks of the first die; and
second data stored in one or more third banks of the first die comprises valid data.

17. The method of claim 13, wherein correcting the one or more errors in the first data comprises:
correcting, in accordance with the data correction scheme and a codeword, the one or more errors in the first data, wherein the codeword comprises the data stored in the plurality of first dies, second data stored in the one or more extra capacity dies, and the parity information.

18. The method of claim 17, further comprising:
correcting, after the corrected first data is written to the first extra capacity die and the null data is written in accordance with the die replacement scheme, one or more second errors in second data stored in at least a second die of the plurality of first dies, wherein the one or more second errors are corrected in accordance with the data correction scheme and a second codeword, and wherein the second codeword comprises the data stored in a subset of the plurality of first dies and in the first extra capacity die, the parity information, and the null data that replaces the first data stored to the first die.

19. The method of claim 13, further comprising:
storing, to the memory system, information that indicates the first die comprises a replaced die based on writing the null data and that indicates one or more banks within the first die that include the null data.

20. The method of claim 13, further comprising:
storing, to the memory system, information that indicates the first extra capacity die is a replacement die based on writing the corrected first data to the first extra capacity die, and that indicates one or more banks within the first extra capacity die that are used to store the corrected first data.

21. The method of claim 13, wherein correcting the one or more errors in at least the first die comprises:
correcting the one or more errors in the first die in accordance with the data correction scheme comprising a single die data correction scheme, wherein the plurality of second dies comprises a first quantity of second dies for storage of the parity information to support the single die data correction scheme.

22. A non-transitory computer-readable medium storing code, the code comprising instructions executable by one or more processors to:
correct, in accordance with a data correction scheme supported by a memory system, one or more errors in first data stored in at least a first die of a plurality of first dies of the memory system, wherein the memory system comprises:
the plurality of first dies for storing data;
a plurality of second dies for storing parity information associated with the data correction scheme; and
one or more extra capacity dies for storing corrected data from one or more first dies of the plurality of first dies in accordance with a die replacement scheme supported by the memory system;
write the corrected first data to at least a first extra capacity die of the one or more extra capacity dies in accordance with the die replacement scheme; and
write, based on writing the corrected first data to the first extra capacity die, null data to replace the first data previously stored to the first die.
